(19) United States
(12) Patent Application Publication
(10) Pub. No.: US 2022/0318599 A1
(43) Pub. Date: Oct. 6, 2022

(54) COMPUTER-READABLE RECORDING MEDIUM STORING CHECK PROGRAM, INFORMATION PROCESSING DEVICE, AND CHECK METHOD

(71) Applicant: FUJITSU LIMITED, Kawasaki-shi (JP)

(72) Inventor: Akihiro TABUCHI, Kawasaki (JP)

(73) Assignee: FUJITSU LIMITED, Kawasaki-shi (JP)

(21) Appl. No.: 17/527,208

(22) Filed: Nov. 16, 2021

(30) Foreign Application Priority Data
Mar. 31, 2021 (JP) 2021-060652

(51) Int. Cl. G06N 3/04; G06K 9/62

(52) U.S. Cl. CPC G06N 3/0454; G06K 9/6202; G06K 9/6261

(57) ABSTRACT

A non-transitory computer-readable recording medium storing a check program for causing a computer to execute processing including: acquiring neural networks to be compared; dividing the acquired neural networks to be compared into respective comparable partial neural networks from beginnings; inputting same data to the respective divided partial neural networks and comparing output results for the input data; and repeating the division processing and the comparison processing until end of the neural networks in a case where the output results are determined to be equal.

### CROSS-REFERENCE TO RELATED APPLICATION

This application is based upon and claims the benefit of priority of the prior Japanese Patent Application No. 2021-60652, filed on Mar. 31, 2021, the entire contents of which are incorporated herein by reference.

### FIELD

The embodiment discussed herein is related to a technology for checking equivalence of neural networks.

### BACKGROUND

There are many frameworks for neural networks. Examples of the frameworks include TensorFlow (registered trademark), Pytorch (registered trademark), and mxnet (registered trademark).

A model of a neural network created and trained in one framework is sometimes desired to be ported to another framework. For example, this is because there is a case where a faster framework is desired to be used or a case where an accelerator desired to be used to increase processing power is supported by only another framework.

In such a case, open neural exchange (ONNX) has been proposed as a format for exchanging neural network models among various frameworks. However, ONNX still has not been able to conduct complete transformation between frameworks. For example, TensorFlow and mxnet can be converted to each other, but TensorFlow and Pytorch has not been able to be converted to each other.

Here, a technology regarding a learning model evaluation method for comparing behaviors of a first learning model and a second learning model is disclosed. In such a technology, a first execution result based on the first learning model and a second execution result based on the second learning model are obtained, whether the first and second execution results satisfy a logical formula is determined, and behaviors of the first learning model and the second learning model are compared on the basis of a determination result.

An example of the related art includes as follows: Japanese Laid-open Patent Publication No. 2020-4178.

### SUMMARY

According to an aspect of the embodiments, there is provided a non-transitory computer-readable recording medium storing a check program for causing a computer to execute processing. In an example, the processing includes: acquiring neural networks to be compared; dividing the acquired neural networks to be compared into respective comparable partial neural networks from beginnings; inputting same data to the respective divided partial neural networks and comparing output results for the input data; and repeating the division processing and the comparison processing until end of the neural networks in a case where the output results are determined to be equal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration of an information processing device according to an embodiment;

FIG. 2A is a diagram (1) for describing partial NN comparison according to the embodiment;

FIG. 2B is a diagram (2) for describing partial NN comparison according to the embodiment;

FIG. 3 is a diagram for describing check processing according to the embodiment;

FIG. 4 is a diagram illustrating an example of a flowchart of the check processing according to the embodiment;

FIG. 5 is a diagram illustrating an example of a flowchart of partial NN search processing according to the embodiment;

FIG. 6 is a diagram illustrating an example of partial NN search according to the embodiment;

FIG. 7 is a diagram illustrating another example of the partial NN search according to the embodiment;

FIG. 8 is a diagram illustrating a hardware configuration example; and

FIG. 9 is a diagram for describing that check of equivalence is difficult.

### DESCRIPTION OF EMBODIMENTS

However, there is a problem that it is difficult to check equivalence indicating whether the neural networks (NNs) to be compared are functionally the same. Such a problem will be described.

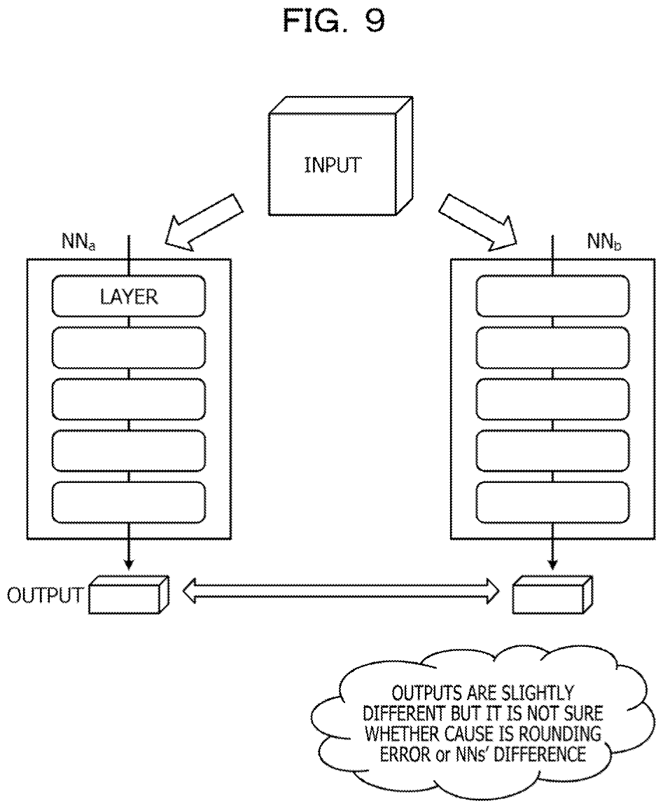

FIG. 9 is a reference diagram for describing the difficulty in checking the equivalence. As illustrated in FIG. 9, the same data is input to an NNₐ and an NN_{b} to be compared and output results are compared to check the equivalence between the NNs.

Here, in checking the equivalence between NNs, the equivalence of calculations needs to be considered in the following points. (1) Floating point numbers are mainly used in the calculation of NNs. Therefore, a difference due to a rounding error at the time of calculation needs to be taken into consideration. (2) The calculation may be replaced by an algorithm with a smaller amount of calculation depending on a layer. Therefore, an error caused by a difference in algorithm needs to be taken into consideration. For example, there is a case where convolution is replaced by a fast Fourier transform (FFT). (3) The NN to be compared may be a layer in which a plurality of layers and a plurality of layers are fused. Therefore, the error due to the difference in the layer structure needs to be taken into consideration. For example, there is a case of the difference due to the layer structure such as an NN having a convolution layer (convolution) and a bias layer (bias) independently and an NN having a layer in which a convolution layer and a bias layer are fused.

However, even if the outputs for the same input are compared for the entire NNs to be compared, it is difficult to determine whether the cause of the difference in the outputs is an error such as a rounding error or an NNs' difference. For example, the error due to the differences in rounding error and algorithm and the error due to a difference in layer structure are acceptable for functional identity, but it is difficult to determine whether the cause of the difference in the outputs is these errors or the NNs' difference. Furthermore, since the number of output elements is smaller than the number of input elements, there is less material for determination.

Therefore, it is difficult to check the equivalence indicating whether the NNs to be compared are functionally the same.

In one aspect, an object is to check equivalence indicating whether neural networks to be compared are functionally the same.

Hereinafter, embodiments of a check program, an information processing device, and a check method will be described in detail with reference to the drawings. Note that the embodiments are not limited to the present disclosure. Furthermore, the embodiments can be appropriately combined within a range without inconsistency.

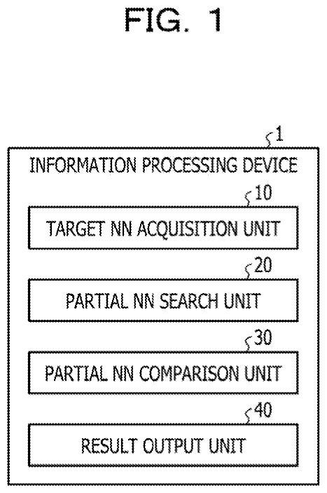

FIG. 1 is a block diagram illustrating a functional configuration of an information processing device according to an embodiment. An information processing device 1 acquires two neural networks to be compared (hereinafter abbreviated as “NNs”), selects a comparable partial NN from beginning of each NN, and checks whether the two NNs are functionally the same in units of partial NNs. Note that the partial NN referred to here may be a single layer in the NN or may be a layer in which a plurality of layers is combined.

The information processing device 1 has a target NN acquisition unit 10, a partial NN search unit 20, a partial NN comparison unit 30, and a result output unit 40. Note that the target NN acquisition unit 10 is an example of an acquisition unit. The partial NN search unit 20 is an example of a division unit. The partial NN comparison unit 30 is an example of a comparison unit.

The target NN acquisition unit 10 acquires the two NNs to be compared. For example, the target NN acquisition unit 10 may acquire the two NNs to be compared from an external device via a network or may acquire the two NNs to be compared from a storage unit (not illustrated) stored in advance.

The partial NN search unit 20 searches for comparable partial NNs from the beginnings of the two NNs to be compared.

Here, an example of a selection criterion of the partial NNs includes identity of layer types. Examples of the layer types include a convolution layer, a bias layer, a dense layer, a relu layer, a reshape layer, a transpose layer, an activation layer, and the like. A name of each layer type of each NN is stored in a model of the each NN. Note that the convolution layer will be hereafter abbreviated as “cony layer”.

Furthermore, the selection criterion of the partial NNs includes identity of output shapes (which still falls within the range of identity even if the order of dimensions changes). Furthermore, the selection criterion of the partial NNs includes the identity of closest output locations when data is input. Furthermore, the selection criterion of the partial NNs may be a combination of the identity of layer types, the identity of output shapes, and the identity of output locations. In the following description, the identity of layer types will be described as an example.

For example, the partial NN search unit 20 selects the minimum comparable partial NNs from the beginnings of the two NNs to be compared on the basis of the layer types. Then, the partial NN search unit 20 determines in advance a maximum partial NN size indicating a maximum number of layers constituting the partial NN, and selects a larger partial NN having an NN size that is equal to or smaller than the maximum partial NN size. The reason for selecting a larger partial NN is to reduce the number of comparisons by the partial NN comparison unit 30, which will be described below. That is, for example, the partial NN search unit 20 selects the partial NN as large as possible within a range in which the error does not increase, whereby reducing the number of comparisons by the partial NN comparison unit 30.

Furthermore, when selecting a larger partial NN, the partial NN search unit 20 searches for the partial NN on the basis of the following conditions <1> and <2>. <1> In a case of including the cony layer or the dense layer, the partial NN includes only one layer. This is because the cony layer and the dense layer have a large calculation amount in one layer, so the rounding error tends to be large. <2> Among the partial NNs and immediately following layers, the layers except for one layer are element-wise and linear-transformation layers, or are layers that changes in only data shape. This is because if the layers are element-wise and linear-transformation layers, the rounding error is relatively small even if the rounding error is added for each layer. Meanwhile, in a case of non-linear transformation such as activation, there is a high possibility of losing value change itself. Furthermore, the value itself does not change in the case of the layer that changes in only data shape. Note that the layers satisfying <2> includes, for example, a bias layer, a reshape layer, and a transpose layer.

The partial NN comparison unit 30 inputs the same data to the corresponding partial NNs of the two NNs to be compared, and compares the output results for the input data. The reason for making a comparison in units of partial NNs is to avoid accumulation of errors in later layers. The reason for inputting the same data to the partial NNs is to improve the accuracy of comparison.

For example, the partial NN comparison unit 30 inputs the same value to layer weights of the corresponding partial NNs selected by the partial NN search unit 20. The weight to be input is a uniform random number or a trained weight, and is a value that can be expressed by a data type used in each partial NN. Then, the partial NN comparison unit 30 inputs the same data to the corresponding partial NNs from the front, performs forward propagation, and acquires the output results. The data to be input is a uniform random number or the like, and is a value that can be expressed by the data type used in each partial NN. Then, the partial NN comparison unit 30 compares the output results and determines that the output results are functionally the same candidate in a case where a comparison result is equal to or less than a predetermined permissible error E. In addition, the partial NN comparison unit 30 inputs the same data to the corresponding partial NNs from behind, performs back propagation, and acquires the output results. The data to be input is a uniform random number or the like, and is a value that can be expressed by the data type used in each partial NN. Then, the partial NN comparison unit 30 compares the output results and gradients of the weights, and determines that the output results are functionally the same candidates in a case where the comparison results are equal to or less than the predetermined permissible error E. Then, the partial NN comparison unit 30 determines that the determination results are functionally the same when the determination results acquired from the forward propagation and the back propagation are both functionally the same candidate. Note that the data to be input to the corresponding partial NNs is not limited to one, and a plurality of data is desirable. This is to improve the accuracy of the identity determination.

Furthermore, in the case of determining that the corresponding partial NNs are functionally the same as a result of comparing the corresponding partial NNs, the partial NN comparison unit 30 excludes the corresponding partial NNs from the NNs to be compared. Then, the search processing by the partial NN search unit 20 and the comparison processing by the partial NN comparison unit 30 are repeated for the NNs to be compared after exclusion until one of the NNs to be compared after exclusion reaches to the end.

The result output unit 40 outputs a result indicating that the NNs to be compared are functionally the same when the NNs to be compared after exclusion are both at the end. Furthermore, the result output unit 40 outputs a result indicating that the NNs to be compared are not functionally the same when either one of the NNs to be compared after exclusion is at the end. Furthermore, the result output unit 40 outputs a result indicating that the NNs to be compared are not functionally the same even in a case where the partial NN is not searched by the partial NN search unit 20.

[Description of Partial NN Comparison]

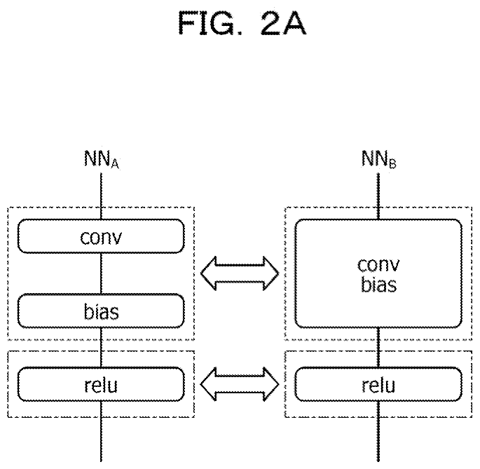

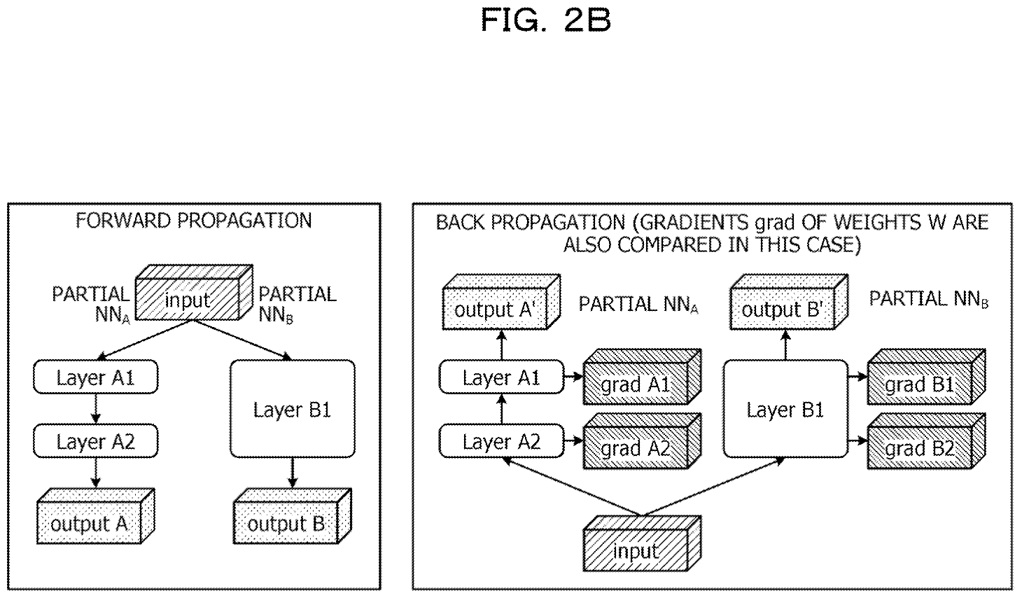

Here, the partial NN comparison according to the embodiment will be described with reference to FIGS. 2A and 2B. FIGS. 2A and 2B are diagrams for describing partial NN comparison according to the embodiment. As illustrated in FIG. 2A, the partial NN search unit 20 selects the minimum comparable partial NNs from the beginnings of the two NNs to be compared on the basis of the layer types. Then, the partial NN comparison unit 30 makes a comparison in units of partial NNs.

Here, the two NNs to be compared are assumed to be an NN_{A} and an NN_{B}. Each frame is assumed to be each layer. Since the NN_{B} contains a layer in which cony and bias are fused, the search processing and the comparison processing are performed in this unit. For example, the partial NN search unit 20 selects a partial NN_{A} in which the cony layer and the bias layer are combined, which is extracted from the NN_{A}, and a partial NN_{B} that is a layer in which cony and bias are fused, which is extracted from the NN_{B} on the basis of the layer types. Then, the partial NN comparison unit 30 compares the selected partial NN_{A} with the selected partial NN_{B}. Then, when the comparison results are functionally the same, the partial NN comparison unit 30 shifts to the search and comparison of the next partial NNs. That is, for example, the partial NN search unit 20 selects a partial NN_{A} including the relu layer of the NN_{A} and a partial NN_{B} including the relu layer of the NN_{B} on the basis of the layer type. Then, the partial NN comparison unit 30 compares the selected partial NN_{A} with the selected partial NN_{B}.

FIG. 2B illustrates the comparison between the partial NN_{A} and the partial NN_{B}. As illustrated in FIG. 2B, the partial NN comparison unit 30 performs the forward propagation and the back propagation for the corresponding partial NNs, and determines that the partial NNs are functionally the same when both the difference between the output results by the forward propagation and the difference between the output results by the back propagation are equal to or less than the permissible error ε. Note that, in FIG. 2B, the partial NN_{A} indicates the partial NN in which a layer A1 and a layer A2 are combined. The partial NN_{B} indicates a partial NN including a layer B1.

The left figure in FIG. 2B illustrates the comparison by the forward propagation between the partial NN_{A} and the partial NN_{B}. The partial NN comparison unit 30 inputs the same value to the layer weights W of the partial NN_{A} and the partial NN_{B}. Then, the partial NN comparison unit 30 inputs the same data to the partial NN_{A} and the partial NN_{B} from the front and performs the forward propagation, and acquires an output A and an output B. Then, the partial NN comparison unit 30 compares the output A and the output B, and determines that they are functionally the same candidates when the comparison result is equal to or less than the predetermined permissible error ε.

The right figure in FIG. 2B illustrates the comparison by the back propagation between the partial NN_{A} and the partial NN_{B}. The partial NN comparison unit 30 inputs the same value to the layer weights W of the partial NN_{A} and the partial NN_{B}. Then, the partial NN comparison unit 30 inputs the same data to the corresponding partial NNs from behind and performs the back propagation, and acquires an output A′ and an output B′. Then, the partial NN comparison unit 30 compares the output A′ and the output B′, gradients grad A1 and grad B1 of the weights W, and gradients grad B1 and grad B2 of the weights W, respectively, and determines that they are functionally the same candidates when all the comparison results are equal to or less than the predetermined permissible error ε.

Then, the partial NN comparison unit 30 determines that the partial NN_{A} and the partial NN_{B} are functionally the same when the determination results acquired from the forward propagation and the back propagation are both functionally the same candidates.

[Description of Check Processing]

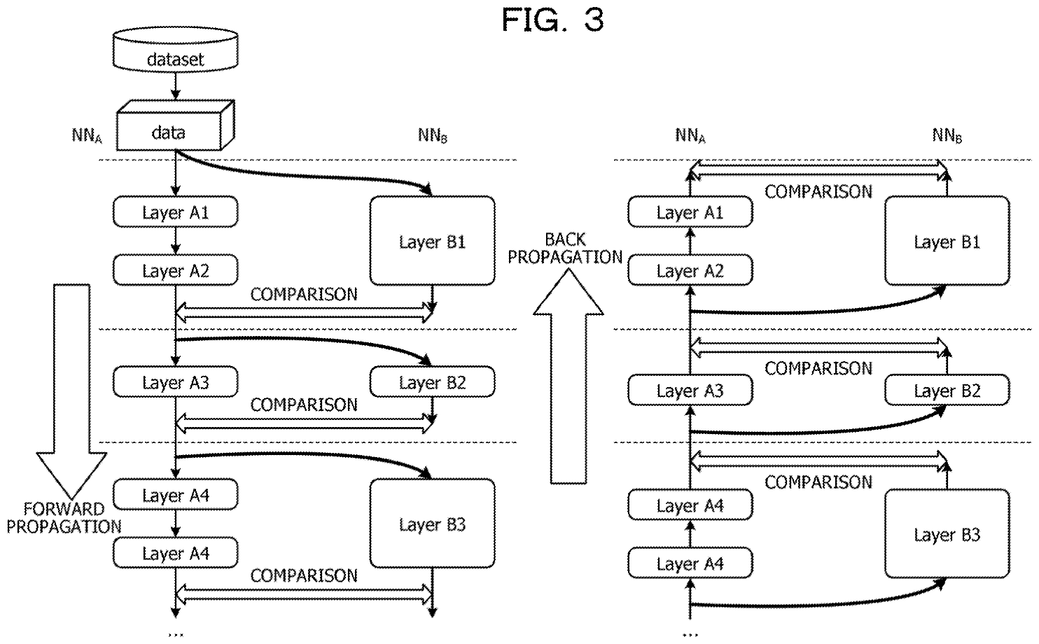

Here, the check processing according to the embodiment will be described with reference to FIG. 3. FIG. 3 is a diagram for describing the check processing according to the embodiment. Note that, as illustrated in FIG. 3, the two NNs to be compared are assumed to be the NN_{A} and the NN_{B}. Each frame is assumed to be each layer.

The partial NN search unit 20 searches for the comparable partial NNs from the beginnings of the two NNs to be compared on the basis of the layer types. Here, for the NN_{A}, the partial NN_{A} in which the layers A1 and A2 are combined is selected. For the NN_{B}, the partial NN_{B} including the layer B1 is selected.

The partial NN comparison unit 30 performs the forward propagation and the back propagation for the corresponding partial NNs, and determines that the partial NNs are functionally the same when both the difference between the output results by the forward propagation and the difference between the output results by the back propagation are equal to or less than the permissible error ε. Here, data is input to one partial NN_{A} and flowed by forward propagation and back propagation, and the input data of the corresponding partial NN_{A} is copied and given to the other partial NN_{B} and flowed by forward propagation and back propagation. The reason for inputting the same input data as the partial NN_{A} to the partial NN_{B} is to improve the accuracy of the comparison. Then, when the difference between the output results output from the forward propagation of the partial NN_{A} and the partial NN_{B} is equal to or less than the permissible error ε, and when the difference between the output results output from the back propagation of the partial NN_{A} and the partial NN_{B} is equal to or less than the permissible error ε, the partial NN_{A} and the partial NN_{B} are determined to be functionally the same. The reason for making a comparison in units of partial NNs is to avoid accumulation of errors in later layers.

Subsequently, the partial NN search unit 20 searches for the comparable partial NNs on the basis of the layer types from the two NNs excluding the partial NNs determined to be the same. Here, for the NN_{A}, the partial NN_{A} including a layer A3 is selected. For the NN_{B}, the partial NN_{B} including a layer B2 is selected.

The partial NN comparison unit 30 performs the forward propagation and the back propagation for the corresponding partial NNs, and determines that the partial NNs are functionally the same in the case where the differences between all the output results of the partial NNs are equal to or less than the permissible error ε. Here, data is input to one partial NN_{A} and flowed by forward propagation and back propagation, and the input data of the corresponding partial NN_{A} is copied and given to the other partial NN_{B} and flowed by forward propagation and back propagation. Then, when the difference between the output results output from the forward propagation of the partial NN_{A} and the partial NN_{B} is equal to or less than the permissible error ε, and when the difference between the output results output from the back propagation of the partial NN_{A} and the partial NN_{B} is equal to or less than the permissible error ε, the partial NN_{A} and the partial NN_{B} are determined to be functionally the same.

Subsequently, the partial NN search unit 20 searches for the comparable partial NNs on the basis of the layer types from the two NNs excluding the partial NNs determined to be the same. Here, for the NN_{A}, the partial NN_{A} in which layers A4 and A4 are combined is selected. For the NN_{B}, the partial NN_{B} including a layer B3 is selected.

The partial NN comparison unit 30 performs the forward propagation and the back propagation for the corresponding partial NNs, and determines that the partial NNs are functionally the same in the case where the differences between all the output results of the partial NNs are equal to or less than the permissible error ε. Here, data is input to one partial NN_{A} and flowed by forward propagation and back propagation, and the input data of the corresponding partial NN_{A} is copied and given to the other partial NN_{B} and flowed by forward propagation and back propagation. Then, when the difference between the output results output from the forward propagation of the partial NN_{A} and the partial NN_{B} is equal to or less than the permissible error ε, and when the difference between the output results output from the back propagation of the partial NN_{A} and the partial NN_{B} is equal to or less than the permissible error ε, the partial NN_{A} and the partial NN_{B} are determined to be functionally the same.

Then, the result output unit 40 outputs a result indicating that the NNs to be compared are functionally the same when the NNs to be compared after exclusion are both at the end. That is, for example, when finally reaching the bottoms of both the NNs, the two NNs as a whole are equal, so the result output unit 40 outputs a result indicating that the two NNs as a whole are equal. Furthermore, the result output unit 40 outputs a result indicating that the NNs to be compared are not functionally the same when either one of the NNs to be compared after exclusion is at the end.

[Flowchart of Check Processing]

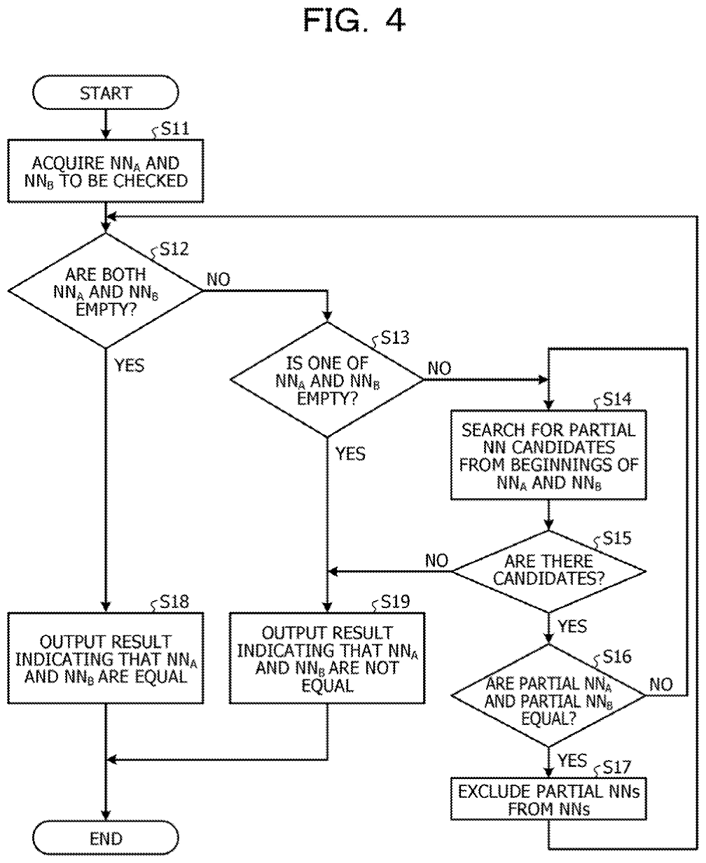

FIG. 4 is a diagram illustrating an example of a flowchart of the check processing according to the embodiment. Note that, in FIG. 4, description will be given assuming that two NNs to be checked are the NN_{A} and the NN_{B}.

First, the target NN acquisition unit 10 acquires the NN_{A} and the NN_{B} to be checked (step S11). Then, the partial NN search unit 20 determines whether both the NN_{A} and the NN_{B} are empty (step S12). That is, for example, the partial NN search unit 20 determines whether both the NN_{A} and the NN_{B} have been checked.

In a case where it is determined that both the NN_{A} and the NN_{B} are not empty (step S12; No), the partial NN search unit 20 determines whether one of the NN_{A} and the NN_{B} is empty (step S13). In a case where it is determined that neither the NN_{A} nor the NN_{B} is empty (step S13; No), the partial NN search unit 20 searches for partial NN candidates from the beginnings of the NN_{A} and the NN_{B} (step S14). Note that a flowchart of the partial NN search processing for searching for partial NN candidates will be described below.

Then, the partial NN search unit 20 determines whether there are partial NN candidates (step S15). In a case where it is determined that there are no partial NN candidates (step S15; No), the partial NN search unit 20 determines that the NN_{A} and the NN_{B} are not equivalent and proceeds to step S19.

On the other hand, in a case where it is determined that there are partial NN candidates (step S15; Yes), the partial NN comparison unit 30 determines whether the partial NN_{A} and the partial NN_{B} are equal (step S16). For example, the partial NN comparison unit 30 inputs the same value to the layer weights of the partial NN_{A} and the partial NN_{B}. The partial NN comparison unit 30 inputs the same data to the partial NN_{A} and the partial NN_{B} from the front and performs the forward propagation, and acquires the output results. The partial NN comparison unit 30 compares the output results and determines whether the comparison result is equal to or less than the predetermined permissible error ε. In addition, the partial NN comparison unit 30 inputs the same data to the partial NN_{A} and the partial NN_{B} from behind and performs the back propagation, and acquires the output results. The partial NN comparison unit 30 compares the output results and the gradients of the weights. The partial NN comparison unit 30 compares the output results and determines whether the comparison result is equal to or less than the predetermined permissible error ε. Then, in a case of determining that all the output results by the forward propagation and the output results by the back propagation are equal to or less than the permissible error ε, the partial NN comparison unit 30 determines that the partial NN_{A} and the partial NN_{B} are functionally the same (equal). In a case of determining that any one of the output results by the forward propagation and the output results by the back propagation is not equal to or less than the permissible error ε, the partial NN comparison unit 30 determines that the partial NN_{A} and the partial NN_{B} are not functionally the same (not equal).

In the case where it is determined that the partial NN_{A} and the partial NN_{B} are not equal (step S16; No), the partial NN search unit 20 proceeds to step S14 in order to search for the partial NN candidate again. This is because the selected partial NN may be different.

Meanwhile, in the case where it is determined that the partial NN_{A} and the partial NN_{B} are equal (step S16; Yes), the partial NN search unit 20 excludes the partial NNs from the NNs (step S17). That is, for example, the partial NN search unit 20 excludes the partial NN_{A} from the NN_{A} and excludes the partial NN_{B} from the NN_{B}. Then, the partial NN search unit 20 proceeds to step S12 in order to perform processing in the NN_{A} and the NN_{B} after exclusion.

In the case where it is determined that both the NN_{A} and the NN_{B} are empty in step S12 (step S12; Yes), the partial NN search unit 20 outputs a result indicating that the NN_{A} and the NN_{B} are equivalent (step S18). Then the process terminates the check processing.

Furthermore, in the case where it is determined that one of the NN_{A} and the NN_{B} is empty in step S13 (step S13; Yes), the partial NN search unit 20 outputs a result indicating that the NN_{A} and the NN_{B} are not equivalent (step S19). Then the process terminates the check processing.

[Flowchart of Partial NN Search Processing]

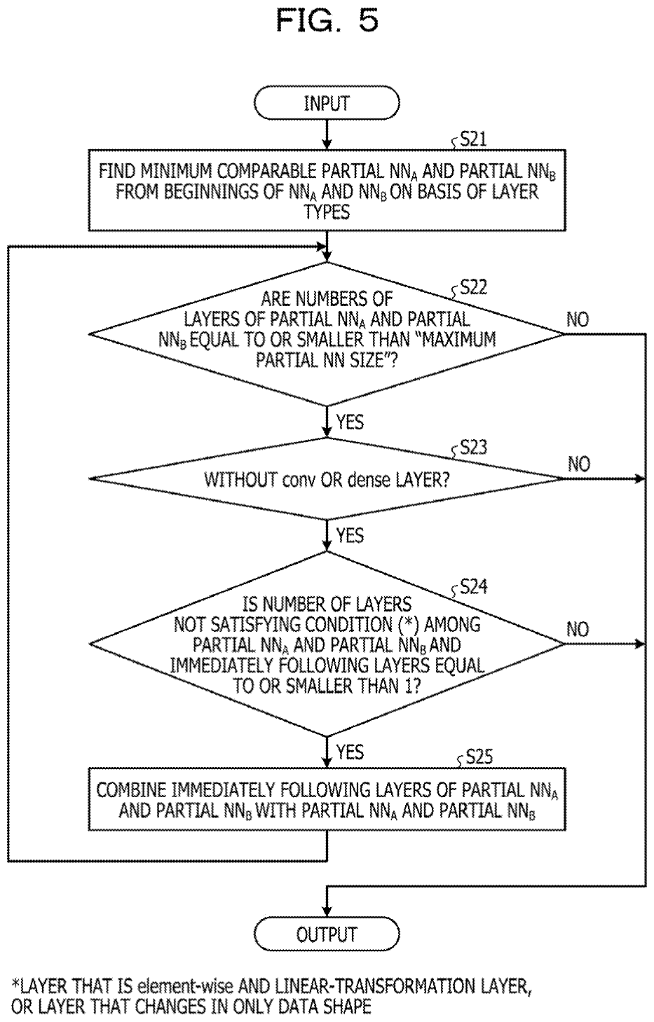

FIG. 5 is a diagram illustrating an example of a flowchart of the partial NN search processing according to the embodiment. Note that, in FIG. 5, description will be given assuming that the NNs to be checked are the NN_{A} and the NN_{B}, similar to FIG. 4.

The partial NN search unit 20 finds the minimum comparable partial NN_{A} and partial NN_{B} from the beginnings of the NN_{A} and NN_{B} on the basis of the layer types (step S21). Then, the partial NN search unit 20 determines whether the numbers of layers of the partial NN_{A} and the partial NN_{B} are equal to or less than the maximum partial NN size (step S22). In a case where it is determined that the numbers of layers of the partial NN_{A} and the partial NN_{B} are larger than the maximum partial NN size (step S22; No), the partial NN search unit 20 terminates the partial NN search processing.

Meanwhile, in a case where it is determined that the numbers of layers of the partial NN_{A} and the partial NN_{B} are equal to or less than the maximum partial NN size (step S22; Yes), whether the partial NN_{A} and the partial NN_{B} do not include the cony layer or the dense layer is determined (step S23). In a case where it is determined that the cony layer or the dense layer is included (step S23; No), the partial NN search unit 20 terminates the partial NN search processing. That is, for example, it is the condition of <1> when selecting a larger partial NN (in a case of including the cony layer or the dense layer, the partial NN includes only one layer). This is because the cony layer and the dense layer have a large calculation amount in one layer, so the rounding error tends to be large.

In a case where it is determined that the cony layer or the dense layer is not included (step S23; Yes), the partial NN search unit 20 performs the following processing. The partial NN search unit 20 determines whether the number of layers not satisfying a predetermined condition among the partial NN_{A}, the partial NN_{B}, and the immediately following layers is 1 or less (step S24). The predetermined condition is that the layer is an element-wise and linear-transformation layer, or is a layer that changes in only data shape. That is, for example, it is the condition of <2> when selecting a larger partial NNs (among the partial NNs and immediately following layers, the layers except for one layer are element-wise and linear-transformation layers, or are layers that changes in only data shape). This is because if the layers are element-wise and linear-transformation layers, the rounding error is relatively small even if the rounding error is added for each layer. Furthermore, the value itself does not change in the case of the layer that changes in only data shape.

In a case where it is determined that the number of layers not satisfying the predetermined condition among the partial NN_{A}, the partial NN_{B}, and the immediately following layers is not 1 or less, or is 2 or more (step S24; No), the partial NN search unit 20 terminates the partial NN search processing.

Meanwhile, in a case where it is determined that the number of layers not satisfying the predetermined condition among the partial NN_{A}, the partial NN_{B}, and the immediately following layers is 1 or less (step S24; Yes), the partial NN search unit 20 performs the following processing. The partial NN search unit 20 combines the layers immediately after the partial NN_{A} and the partial NN_{B} with the partial NN_{A} and the partial NN_{B} (step S25). Then, the partial NN search unit 20 proceeds to step S22 in order to continue the partial NN search processing.

Thereby, the check processing performed by the information processing device 1 can check whether the NNs to be compared are functionally the same while reducing the influence of the rounding errors and the like.

[Example of Partial NN Search]

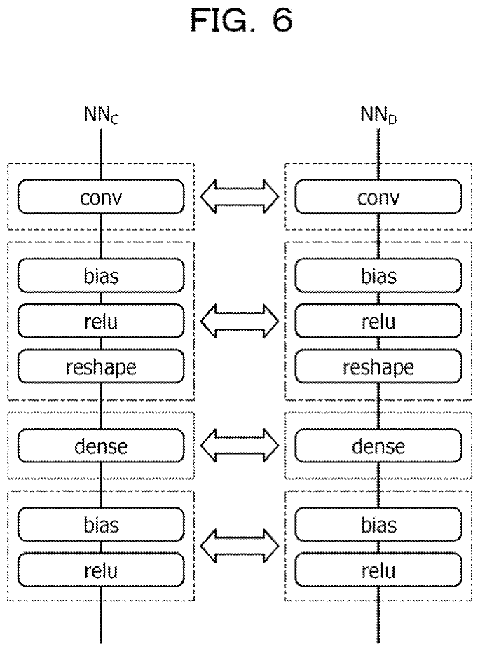

FIG. 6 is a diagram illustrating an example of partial NN search according to the embodiment. Note that the two NNs to be compared are assumed to be an NN_{C} and an NN_{D}. Each frame is assumed to be each layer. Furthermore, the maximum partial NN size is assumed to be 3, for example. Furthermore, the relu layer is a layer that is not linear-transformation. The bias layer and the reshape layer are layers that are linear-transformation and change in only shape.

The partial NN search unit 20 selects minimum comparable partial NN_{C} and partial NN_{D} from the beginnings of the NN_{C} and NN_{D} to be compared on the basis of the layer types. Here, the partial NN_{C} and the partial NN_{D} including the cony layer are selected. Then, the partial NN search unit 20 sets the partial NN_{C} and the partial NN_{D} including the cony layer as the partial NN candidates because the partial NN_{C} and the partial NN_{D} include the cony layer. Then, the partial NN comparison unit 30 compares the partial NN_{C} with the partial NN_{D}, and checks whether they are functionally the same. Here, it is assumed that the partial NN_{C} and the partial NN_{D} are determined to be functionally the same. Then, the partial NN search unit 20 excludes the partial NN_{C} from the NN_{C} and excludes the partial NN_{D} from the NN_{D}.

Next, the partial NN search unit 20 selects the minimum comparable partial NN_{C} and partial NN_{D} from the beginnings of the NN_{C} and NN_{D} after exclusion on the basis of the layer types. Here, the partial NN_{C} and the partial NN_{D} including the bias layer are selected. Then, the partial NN search unit 20 proceeds to the next processing because the partial NNs have the NN size that is equal to or less than the maximum partial NN size (“3”), and the partial NN_{C} and the partial NN_{D} do not include the cony layer or the dense layer. Then, the partial NN search unit 20 combines the partial NN_{C} and the partial NN_{D} with the immediately following relu layers because the number of layers not satisfying the condition among the partial NN_{C}, the partial NN_{D}, and the immediately following relu layers is 1 or less. Since the relu layer is not a linear-transformation layer but the bias layer is a linear-transformation layer and a layer that changes in only shape, and the number of layers not satisfying the condition is 1 or less, the relu layer is combined with each partial NN. Then, the partial NN search unit 20 proceeds to the next processing because the partial NNs have the NN size that is equal to or less than the maximum partial NN size (“3”), and the partial NN_{C} and the partial NN_{D} do not include the cony layer or the dense layer. Then, the partial NN search unit 20 combines the partial NN_{C} and the partial NN_{D} with the immediately following reshape layers because the number of layers not satisfying the condition among the partial NN_{C}, the partial NN_{D}, and the immediately following reshape layers is 1 or less. Then, the partial NN search unit 20 sets the partial NN_{C} and partial NN_{D} including the bias, relu, and reshape layers as the partial NN candidates because the partial NNs have a partial NN size that is equal to or smaller than the maximum partial NN size (“3”) but the immediately following layers include the cony layer or the dense layer. Then, the partial NN comparison unit 30 compares the partial NN_{C} and the partial NN_{D}, and checks whether they are functionally the same. Here, it is assumed that the partial NN_{C} and the partial NN_{D} are determined to be functionally the same. Then, the partial NN search unit 20 excludes the partial NN_{C} from the NN_{C} and excludes the partial NN_{D} from the NN_{D}.

Next, the partial NN search unit 20 selects the minimum comparable partial NN_{C} and partial NN_{D} from the beginnings of the NN_{C} and NN_{D} after exclusion on the basis of the layer types. Here, the partial NN_{C} and the partial NN_{D} including the dense layer are selected. Then, since the partial NN search unit 20 sets the partial NN_{C} and the partial NN_{D} including the dense layer as the partial NN candidates because the partial NN_{C} and the partial NN_{D} include the dense layer. Then, the partial NN comparison unit 30 compares the partial NN_{C} and the partial NN_{D}, and checks whether they are functionally the same. Here, it is assumed that the partial NN_{C} and the partial NN_{D} are determined to be functionally the same. Then, the partial NN search unit 20 excludes the partial NN_{C} from the NN_{C} and excludes the partial NN_{D} from the NN_{D}.

Next, the partial NN search unit 20 selects the minimum comparable partial NN_{C} and partial NN_{D} from the beginnings of the NN_{C} and NN_{D} after exclusion on the basis of the layer types. Here, the partial NN_{C} and the partial NN_{D} including the bias layer are selected. Then, the partial NN search unit 20 proceeds to the next processing because the partial NNs have the NN size that is equal to or less than the maximum partial NN size (“3”), and the partial NN_{C} and the partial NN_{D} do not include the cony layer or the dense layer. Then, the partial NN search unit 20 combines the partial NN_{C} and the partial NN_{D} with the immediately following relu layers because the number of layers not satisfying the condition among the partial NN_{C}, the partial NN_{D}, and the immediately following relu layers is 1 or less. Since the relu layer is not a linear-transformation layer but the bias layer is a linear-transformation layer and a layer that changes in only shape, and the number of layers not satisfying the condition is 1 or less, the relu layer is combined with each partial NN. Thereafter, the partial NN comparison unit 30 compares the partial NN_{C} and the partial NN_{D}, and checks whether they are functionally the same.

Then, the result output unit 40 outputs a result indicating that the NNs to be compared are functionally the same when the NN_{C} and NN_{D} to be compared from which the same partial NNs are excluded are both at the end. In contrast, the result output unit 40 outputs a result indicating that the NNs to be compared are not functionally the same when either one of the NN_{C} or NN_{D} to be compared from which the same partial NNs are excluded is at the end.

[Another Example of Partial NN Search]

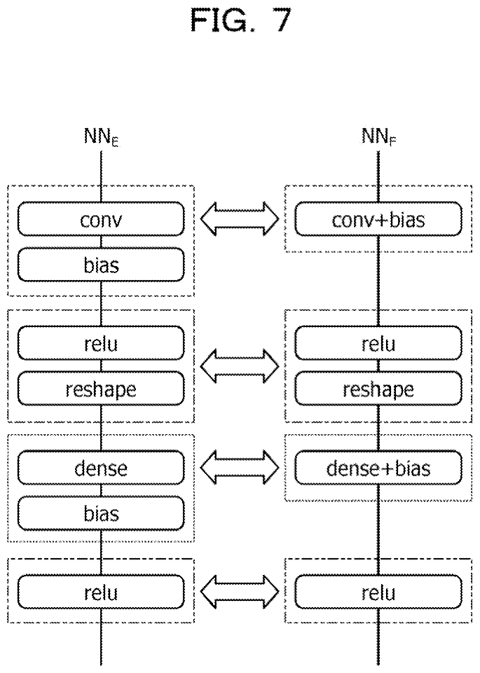

FIG. 7 is a diagram illustrating another example of the partial NN search according to the embodiment. Note that the two NNs to be compared are assumed to be an NN_{E} and an NN_{F}. Each frame is assumed to be each layer. Furthermore, the maximum partial NN size is assumed to be 2, for example. Furthermore, the relu layer is a layer that is not linear-transformation. The bias layer and the reshape layer are layers that are linear-transformation and change in only shape.

The partial NN search unit 20 selects minimum comparable partial NN_{E} and partial NN_{F} from the beginnings of the NN_{E} and NN_{F} to be compared on the basis of the layer types. Here, the NN_{F} is a layer in which bias and cony are fused. Therefore, the partial NN_{E} including the cony layer and the bias layer, and the partial NN_{F} including the layer in which cony and bias are fused are selected. Then, since the partial NN search unit 20 sets the partial NN_{E} and the partial NN_{F} including the cony layer as the partial NN candidates because the partial NN_{E} and the partial NN_{F} include the cony layer. Then, the partial NN comparison unit 30 compares the partial NN_{E} and the partial NN_{F}, and checks whether they are functionally the same. Here, it is assumed that the partial NN_{E} and the partial NN_{F} are determined to be functionally the same. Then, the partial NN search unit 20 excludes the partial NN_{E} from the NN_{E} and excludes the partial NN_{F} from the NN_{F}.

Next, the partial NN search unit 20 selects the minimum comparable partial NN_{E} and partial NN_{F} from the beginnings of the NN_{E} and NN_{F} after exclusion on the basis of the layer types. Here, the partial NN_{E} and the partial NN_{F} including the relu layer are selected. Then, the partial NN search unit 20 proceeds to the next processing because the partial NNs have the NN size that is equal to or less than the maximum partial NN size (“2”), and the partial NN_{E} and the partial NN_{F} do not include the cony layer or the dense layer. Then, the partial NN search unit 20 combines the partial NN_{E} and the partial NN_{F} with the immediately following reshape layers because the number of layers not satisfying the condition among the partial NN_{E}, the partial NN_{F}, and the immediately following reshape layers is 1 or less. Since the relu layer is not a linear-transformation layer but the reshape layer is a linear-transformation layer and a layer that changes in only shape, and the number of layers not satisfying the condition is 1 or less, the reshape layer is combined with each partial NN. Then, the partial NN search unit 20 sets the partial NN_{E} and partial NN_{F} including the relu and reshape layers as the partial NN candidates because the partial NNs have a partial NN size that is equal to or smaller than the maximum partial NN size (“2”) but the immediately following layers include the cony layer or the dense layer. Then, the partial NN comparison unit 30 compares the partial NN_{E} and the partial NN_{F}, and checks whether they are functionally the same. Here, it is assumed that the partial NN_{E} and the partial NN_{F} are determined to be functionally the same. Then, the partial NN search unit 20 excludes the partial NN_{E} from the NN_{E} and excludes the partial NN_{F} from the NN_{F}.

The partial NN search unit 20 selects the minimum comparable partial NN_{E} and partial NN_{F} from the beginnings of the NN_{E} and NN_{F} after exclusion on the basis of the layer types. Here, the NN_{F} is a layer in which bias and dense are fused. Therefore, the partial NN_{E} including the dense layer and the bias layer, and the partial NN_{F} including the layer in which dense and bias are fused are selected. Then, since the partial NN search unit 20 sets the partial NN_{E} and the partial NN_{F} including the dense layer as the partial NN candidates because the partial NN_{E} and the partial NN_{F} include the dense layer. Then, the partial NN comparison unit 30 compares the partial NN_{E} and the partial NN_{F}, and checks whether they are functionally the same. Here, it is assumed that the partial NN_{E} and the partial NN_{F} are determined to be functionally the same. Then, the partial NN search unit 20 excludes the partial NN_{E} from the NN_{E} and excludes the partial NN_{F} from the NN_{F}.

Next, the partial NN search unit 20 selects the minimum comparable partial NN_{E} and partial NN_{F} from the beginnings of the NN_{E} and NN_{F} after exclusion on the basis of the layer types. Here, the partial NN_{E} and the partial NN_{F} including the relu layer are selected. Thereafter, the partial NN comparison unit 30 compares the partial NN_{E} and the partial NN_{F} and checks whether they are functionally the same.

Then, the result output unit 40 outputs a result indicating that the NNs to be compared are functionally the same when the NN_{C} and NN_{D} to be compared from which the same partial NNs are excluded are both at the end. In contrast, the result output unit 40 outputs a result indicating that the NNs to be compared are not functionally the same when either one of the NN_{C} or NN_{D} to be compared from which the same partial NNs are excluded is at the end.

### Effects of Embodiment

According to the above embodiment, the information processing device 1 acquires the neural networks to be compared. The information processing device 1 divides the acquired neural networks to be compared into the respective comparable partial neural networks from the beginnings. The information processing device 1 inputs the same data to the respective divided partial neural networks, and compares the output results for the input data. Then, in the case where the output results are determined to be equal, the information processing device 1 repeats the division processing and the comparison processing until the end of the neural networks. As a result, the information processing device 1 can check the equivalence indicating whether the neural networks to be compared are functionally the same by repeating the comparison as to whether the neural networks to be compared are equal in units of comparable partial neural networks.

Furthermore, according to the above embodiment, the information processing device 1 divides the neural networks to be compared into the respective partial neural networks on the basis of the layer types. As a result, the information processing device 1 can divide the neural network to be compared into the partial neural networks of the same type by using the layer types, and can check the functional identity of the partial neural networks.

Furthermore, according to the above embodiment, the information processing device 1 divides the neural networks so that only one layer is included even when the convolution layer or the dense layer is included in the partial neural network. As a result, the information processing device 1 can prevent the rounding error from becoming large by using only one layer having a large calculation amount in the partial neural network. As a result, the information processing device 1 can accurately check whether the neural networks to be compared are functionally the same while reducing the influence of the rounding error.

Furthermore, according to the above embodiment, the information processing device 1 further divides the partial neural networks so that among the layers included in the partial neural networks and the immediately following layers, the number of layers not satisfying the predetermined condition that the influence of the rounding error becomes insignificant is equal to or less than 1. Thereby, the information processing device 1 can prevent the rounding error from becoming large by setting the number of layers not satisfying the condition that the influence of the rounding error becomes insignificant to 1 or less for the layers included in the partial neural networks. As a result, the information processing device 1 can accurately check whether the neural networks to be compared are functionally the same while reducing the influence of the rounding error.

Furthermore, according to the above embodiment, the predetermined condition is that the layer is an element-wise and linear-transformation layer or is a layer that changes in only data shape. As a result, the information processing device 1 can prevent the rounding error from becoming large by setting the number of layers not satisfying the predetermined condition to 1 or less. As a result, the information processing device 1 can accurately check whether the neural networks to be compared are functionally the same while reducing the influence of the rounding error.

Furthermore, according to the above embodiment, the information processing device 1 sets the same weight for the respective partial neural networks, inputs the same data to the partial neural networks to the front, and compares the output results output to the rear side. In addition, the information processing device 1 sets the same weight for the respective partial neural networks, inputs the same data to the partial neural networks to the rear side, and compares the output results output to the front side and the gradients of the weights. As a result, the information processing device 1 can improve the accuracy of comparison by sharing the input data with respect to the partial neural network to be compared. Furthermore, the information processing device 1 can further improve the accuracy of comparison by comparing not only the output results but also the gradients of the weights.

[Others]

Note that the above embodiment has been described assuming that the number of NNs to be compared is two. That is, for example, the information processing device 1 acquires the two NNs to be compared, selects the comparable partial NNs from beginnings of each NN, and checks whether the two NNs are functionally the same in units of partial NNs. However, the number of NNs to be compared is not limited to two, and may be three or more.

Furthermore, any information indicated in this document or the drawings, including the processing procedures, control procedures, specific names, and various sorts of data and parameters can be arbitrarily modified unless otherwise noted.

In addition, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part thereof may be configured by being functionally or physically distributed or integrated in optional units according to various types of loads, usage situations, or the like.

Moreover, all or any part of individual processing functions performed in each device may be implemented by a central processing unit (CPU) and a program analyzed and executed by the CPU, or may be implemented as hardware by wired logic.

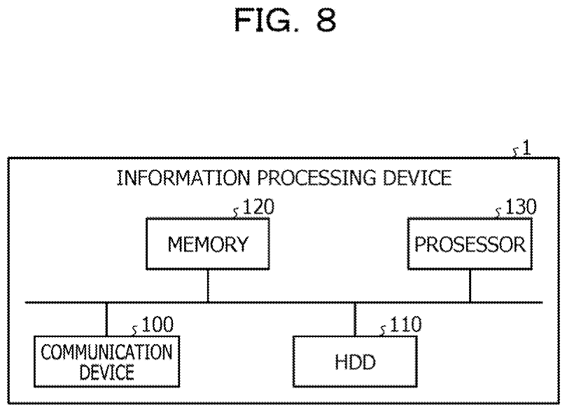

FIG. 8 is a diagram illustrating a hardware configuration example. As illustrated in FIG. 8, an information processing device 1 includes a communication device 100, a hard disk drive (HDD) 110, a memory 120, and a processor 130. Furthermore, the units illustrated in FIG. 8 are mutually connected to each other by a bus or the like.

The communication device 100 is a network interface card or the like and communicates with another device. The HDD 110 stores databases (DBs) and programs that activate the functions illustrated in FIG. 1.

The processor 130 reads a program that executes processing similar to that of each processing unit illustrated in FIG. 1 from the HDD 110 or the like, and loads it in the memory 120, thereby activating a process that implements each function described with reference to FIG. 1 or the like. For example, this process implements a function similar to that of each processing unit included in the information processing device 1. Specifically, for example, the processor 130 reads a program having similar functions to the target NN acquisition unit 10, the partial NN search unit 20, the partial NN comparison unit 30, the result output unit 40, and the like from the HDD 110 or the like. Then, the processor 130 executes a process of executing similar processing to the target NN acquisition unit 10, the partial NN search unit 20, the partial NN comparison unit 30, the result output unit 40, and the like.

As described above, the information processing device 1 operates as an information processing device that executes a check method by reading and executing a program. Furthermore, the information processing device 1 may also implement functions similar to the functions of the above-described embodiment by reading the program described above from a recording medium by a medium reading device and executing the read program described above. Note that the program mentioned in other embodiment is not limited to being executed by the information processing device 1. For example, the embodiment may be similarly applied to a case where another computer or server executes the program, or a case where these cooperatively execute the program.

This program may be distributed via a network such as the Internet. Furthermore, this program may be recorded on a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a check program for causing a computer to execute processing comprising:
acquiring neural networks to be compared;
dividing the acquired neural networks to be compared into respective comparable partial neural networks from beginnings;
inputting same data to the respective divided partial neural networks and comparing output results for the input data; and
repeating the division processing and the comparison processing until end of the neural networks in a case where the output results are determined to be equal.

2. The non-transitory computer-readable recording medium storing a check program according to claim 1, wherein
the division processing divides the neural networks to be compared into the respective partial neural networks on a basis of a layer type.

3. The non-transitory computer-readable recording medium storing a check program according to claim 1, wherein
the division processing divides the neural networks so that only one layer is included even when a convolution layer or a dense layer is included in the partial neural network.

4. The non-transitory computer-readable recording medium storing a check program according to claim 3, wherein
the division processing further divides the partial neural networks so that among layers included in the partial neural networks and immediately following layers, the number of layers not satisfying a predetermined condition that an influence of a rounding error becomes insignificant is equal to or less than 1.

5. The non-transitory computer-readable recording medium storing a check program according to claim 4, wherein
the predetermined condition is that the layer is an element-wise and linear-transformation layer, or is a layer that changes in only data shape.

6. The non-transitory computer-readable recording medium storing a check program according to claim 1, wherein
the comparison processing sets a same weight for the respective partial neural networks and then inputs same data to a front side, and compares the output results output to a rear side, and sets a same weight for the respective partial neural networks and then input same data to the rear side, and compares the output results output to the front side and gradients of the weights.

7. An information processing device comprising:
a memory; and
a processor coupled to the memory, the processor being configured to perform processing, the processing including:
acquiring neural networks to be compared;
dividing the acquired neural networks to be compared into respective comparable partial neural networks from beginnings;
inputting same data to the respective divided partial neural networks and comparing output results for the input data; and
repeating the division processing and the comparison processing until end of the neural networks in a case where the output results are determined to be equal.

8. A computer-implemented method of a check process, the method comprising:
acquiring neural networks to be compared;
dividing the acquired neural networks to be compared into respective comparable partial neural networks from beginnings;
inputting same data to the respective divided partial neural networks and comparing output results for the input data; and
repeating the division processing and the comparison processing until end of the neural networks in a case where the output results are determined to be equal.
